(19) United States
(12) Patent Application Publication
(10) Pub. No.: US 2012/0272786 A1
(43) Pub. Date: Nov. 1, 2012

(54) ACTIVATION MECHANISM FOR A LIQUID COOLED RACK

(75) Inventors: Adrian Correa, San Jose, CA (US); Norman Chow, Milpitas, CA (US)

(73) Assignee: COOLIGY INC., Mountain View, CA (US)

(21) Appl. No.: 13/278,888

(22) Filed: Oct. 21, 2011

Related U.S. Application Data
(60) Provisional application No. 61/406,084, filed on Oct. 22, 2010.

(51) Int. Cl. F16H 53/06; F16H 53/02

(52) U.S. Cl. 74/569; 74/567

(57) ABSTRACT

A cam shaft is fitted with one or more sleeve bearings to negate friction between the rotating cam shaft and a surface onto which the cam shaft is rotated. A metal sheet is bent upward or downward by rotating cam shafts from a first position to either a second position or a third position. Rotating a cam shaft from the first position to either the second or the third position forces an offset portion of the cam shaft against a side of a U-bend in the metal sheet. The rotation generates a normal force against the U-bend that is translated to a bending of the metal sheet. The rotation also generates a tangential force. The sleeve bearings negate friction that may be generated by the tangential force.

### RELATED APPLICATIONS

This application claims priority of U.S. provisional application, Ser. No. 61/406,084, filed Oct. 22, 2010, and entitled “IMPROVED FLOW BALANCING SCHEME FOR 2-PHASE REFRIGERANT COOLED RACK”. This application incorporates U.S. provisional application, Ser. No. 61/406,084 in its entirety by reference.

### FIELD OF THE INVENTION

The invention relates to a mounting mechanism in general, and specifically, to a mounting mechanism to form a thermal interface between two heat exchanging devices.

### BACKGROUND OF THE INVENTION

Cooling of high performance integrated circuits with high heat dissipation is presenting significant challenge in the electronics cooling arena. Conventional cooling with heat pipes and fan mounted heat sinks are not adequate for cooling chips with ever increasing wattage requirements.

Electronics servers, such as blade servers and rack servers, are being used in increasing numbers due to the higher processor performance per unit volume one can achieve. However, the high density of integrated circuits also leads to high thermal density, which is beyond the capability of conventional air-cooling methods.

A particular problem with cooling integrated circuits on electronics servers is that multiple electronics servers are typically mounted in close quarters within a server chassis. In such configurations, electronics servers are separated by a limited amount of space, thereby reducing the dimensions within which to provide an adequate cooling solution. Typically, stacking of electronics servers does not provide the mounting of large fans and heat sinks for each electronics server. Often electronics server stacks within a single server chassis are cooled with one or more fans, one or more heat sinks, or a combination of both. Using this configuration, the integrated circuits on each electronics server are cooled using the heat sink and the large fan that blows air over the heat sink, or simply by blowing air directly over the electronics servers. However, considering the limited free space surrounding the stacked electronics servers within the server chassis, the amount of air available for cooling the integrated circuits is limited.

As data centers continue to increase their computer density, electronics servers are being deployed more frequently. Fully populated electronics servers significantly increase rack heat production. This requires supplemental cooling beyond what the Computer Room Air Conditioning (CRAC) units can provide. Supplemental cooling systems can include fluid based cooling systems implemented at the server rack level and distributed to each electronics server mounted within the server rack. In some applications, the supplemental cooling system distributes cooling fluid to each docking bay within the server rack, where each docking bay is configured to receive an electronics server. The cooling fluid distributed to each docking bay is distributed to either a discrete fluid based cooling system included within the received electronics server, or to a discrete fluid based cooling system that is part of each docking bay where the discrete fluid based cooling system is thermally coupled to the received electronics server.

A key requirement of server racks is the ability to swap in and out electronics servers. As such, there is a need to effectively connect and disconnect each electronics server and the fluid based cooling system of the corresponding docking bay. U.S. Pat. No. 8,000,103 to Lipp et al. is directed to a system having a flexible cold plate and a mounting mechanism for thermally coupling the flexible cold plate to the top lid of an electronics module mounted in a docking bay of a server rack. Rotation of two cams causes a force on a thin steel plate coupled to the flexible cold plate, resulting in translational motion to the flexible cold plate. The ends of the steel plate form U-bends within which a cam is positioned. Round steel extensions are positioned against one side of each U-bend, the side facing inward toward a flat portion of the steel plate. Each extension extends the length of the steel plate, along the entire length of the U-bend, and functions as a pivot point when force is applied to the U-bend by the cam. When the cam is rotated, a normal force is applied to a surface of each U-bend, which causes a bending deformation in the steel plate. The bending creates an opposing force which is exerted on the cam by the contacting surface of the U-bend. At the point of contact, friction occurs. This friction increases because the displacement caused from the offset of the cam increases the force against the steel plate. Torques can be 150 inch-lbs or more. The cam can be lubricated but the friction can still remain nearly as high. Lubricant is also messy and can eventually find its way onto the electronics modules. Contributing to the friction is the fact that the cam and the steel plate it is pushing against can be of two materials which gall when put in contact with high forces. The cam can be treated with a non-friction or low friction surface to lower the friction between the rotating cam and the steel plate at the U-bend. Such treatments can include PTFE (Teflon) or other fluorinated polymers or ultra high density polyethylene or other polymer or low friction coatings. The treatments can be applied as tapes or coatings. This adds cost and can wear over time, and are still only marginally effective in reducing friction.

### SUMMARY OF THE INVENTION

A mounting mechanism includes new cam shaft design which isolates a rotational force from a translational force by the use of one or more sleeve bearings. The modified cam shafts can be coupled to a metal sheet having a U-bend on each side for the purpose of bending the metal sheet upward or downward. One or more heat exchangers can be coupled to the bending portion of the metal sheet and can be thermally engaged or disengaged to a proximately placed device be bending the metal sheet. Each sleeve bearing in the cam shaft comes in contact with the U-bend in the metal sheet and is free to rotate or not rotate as the force is applied to the metal sheet from the rotating cam. The cam shaft is free to rotate independently within the sleeve bearing. This effectively reduces if not eliminates the kinetic friction against the U-bend of the metal sheet.

In an aspect, a cam shaft includes a cam journal, a cam rod, and one or more sleeve bearings. The cam journal has a first diameter and a center axis. The cam rod has a second diameter less than the first diameter, wherein the cam rod is positioned within the cam journal and a center axis of the cam rod is offset relative to the center axis of the cam journal, further wherein the center axis of the cam rod is a rotational axis of the cam shaft. The one or more sleeve bearings are each coupled around a circumference of the cam journal, wherein the one or more sleeve bearings rotate relative to the cam journal.

In another aspect, a mounting mechanism includes a metal sheet, a first cam shaft, and a second cam shaft. The metal sheet has a first side and a second side, wherein the first side is formed as a first U-bend and the second side is formed as a second U-bend. The first cam shaft is positioned within the first U-bend, wherein the first cam shaft includes a first set of one or more sleeve bearings coupled around a circumference of the first cam shaft. The second cam shaft is positioned within the second U-bend, wherein the second cam shaft includes a second set of one or more sleeve bearings coupled around a circumference of the second cam shaft. In some embodiments, each of the first cam shaft and the second cam shaft includes a cam journal, wherein the one or more sleeve bearings rotate relative to the cam journal. In some embodiments, the cam journal has a first diameter and a center axis, wherein each of the first cam shaft and the second cam shaft includes a cam rod having a second diameter less than the first diameter, wherein the cam rod is positioned within the cam journal and a center axis of the cam rod is offset relative to the center axis of the cam journal, wherein the center axis of the cam rod is a rotational axis of the cam shaft. In some embodiments, the cam journal and the cam rod rotate about the center axis of the cam rod.

In some embodiments, the first cam shaft is configured to rotate within the first U-bend and the second cam shaft is configured to rotate within the second U-bend, wherein rotation of the first cam shaft results in a first normal force and a first tangential force between the first cam shaft and the first U-bend, the first tangential force rotates the first set of one or more sleeve bearings, further wherein rotation of the second cam shaft results in a second normal force and a second tangential force between the second cam shaft and the second U-bend, the second tangential force rotates the second set of one or more sleeve bearings, wherein the first normal force and the second normal force bends a portion of the metal sheet between the first U-bend and the second U-bend. In some embodiments, each of the first cam shaft and the second cam shaft are rotated between a first position, a second position, and a third position such that in the first position the portion of the metal sheet is substantially flat, in the second position the portion of the metal sheet bends upward, and in the third position the portion of the metal sheet bends downward. In some embodiments, each of the first U-bend and the second U-bend include a first side and a second side, the first side positioned proximate to the bending portion of the metal sheet and the second side distal from the bending portion of the metal sheet, wherein when the first cam shaft and the second cam shaft are each in the third position, the normal force is applied to the first side of each of the first cam shaft and the second cam shaft. In some embodiments, when the first cam shaft and the second cam shaft are each in the second position, the normal force is applied to the second side of each of the first cam shaft and the second cam shaft.

In some embodiments, the mounting mechanism further includes one or more heat exchangers coupled to a surface of the metal sheet. In some embodiments, the cam rod of each of the first cam shaft and the second cam shaft includes a first end that extends beyond a first end of the cam journal. In some embodiments, the first end of each cam rod has a bolt shape to mate with an actuating wrench. In some embodiments, each sleeve bearing includes ball bearings. In some embodiments, each sleeve bearing includes needle bearings. In some embodiments, each sleeve bearing includes an inner surface impregnated with a friction reducing material.

In yet another aspect, a system for thermally coupling a heat exchanger to a heat generating electronic device is disclosed. The system includes a mounting mechanism, one or more heat exchangers, and a heat generating electronics device. The mounting mechanism includes a metal sheet, a first cam shaft, and a second cam shaft. The metal sheet has a first side and a second side, wherein the first side is formed as a first U-bend and the second side is formed as a second U-bend. The first cam shaft is positioned within the first U-bend, wherein the first cam shaft includes a first set of one or more sleeve bearings coupled around a circumference of the first cam shaft. The second cam shaft is positioned within the second U-bend, wherein the second cam shaft includes a second set of one or more sleeve bearings coupled around a circumference of the second cam shaft. The one or more heat exchangers are coupled to a surface of the metal sheet. The heat generating electronics device are positioned proximate the metal sheet. The first cam shaft is configured to rotate within the first U-bend and the second cam shaft is configured to rotate within the second U-bend, wherein rotation of the first cam shaft results in a first normal force and a first tangential force between the first cam shaft and the first U-bend, the first tangential force rotates the first set of one or more sleeve bearings, further wherein rotation of the second cam shaft results in a second normal force and a second tangential force between the second cam shaft and the second U-bend, the second tangential force rotates the second set of one or more sleeve bearings, wherein the first normal force and the second normal force bends a portion of the metal sheet between the first U-bend and the second U-bend such that the one or more heat exchangers are thermally coupled to the heat generating electronics device.

In still yet another aspect, a method of thermally coupling a heat exchanger to a heat generating electronic device is disclosed. The method includes rotating a first cam shaft positioned within a first U-bend configured at a first side of a metal sheet and rotating a second cam shaft positioned within a second U-bend configured at a second side of the metal sheet, wherein rotation of the first cam shaft results in a first normal force and a first tangential force between the first cam shaft and the first U-bend, further wherein rotation of the second cam shaft results in a second normal force and a second tangential force between the second cam shaft and the second U-bend. The method includes applying the first tangential force to a first set of one more sleeve bearings coupled to an outer circumference of the first cam shaft, thereby rotating each of the first set of sleeve bearings relative to the first cam shaft. The method further includes applying the second tangential force to a second set of one or more sleeve bearings coupled to an outer circumference of the second cam shaft, thereby rotating each of the second set of sleeve bearings relative to the second cam shaft. The method further includes applying the first normal force and the second normal force to bend a portion of the metal sheet between the first U-bend and the second U-bend such that one or more heat exchangers coupled to the portion of the metal sheet are thermally coupled to the heat generating electronics device.

Other features and advantages of the present invention will become apparent after reviewing the detailed description of the embodiments set forth below.

### BRIEF DESCRIPTION OF THE DRAWINGS

Several example embodiments are described with reference to the drawings, wherein like components are provided with like reference numerals. The example embodiments are intended to illustrate, but not to limit, the invention. The drawings include the following figures:

FIG. 1 illustrates an isometric view of a mounting mechanism according to an embodiment.

FIG. 2 illustrates a cam shaft of FIG. 1.

FIG. 3 illustrates a front view of the mounting mechanism of FIG. 1.

FIG. 4 illustrates a larger view of the front view of a cam shaft and a U-bend of FIG. 3.

FIG. 5 illustrates a front view of the mounting mechanism with the cam shafts in the second position.

FIG. 6 illustrates a larger view of the front view of a cam shaft and a U-bend of FIG. 5.

FIG. 7 illustrates a front view of the mounting mechanism with the cam shafts in the third position.

FIG. 8 illustrates a larger view of the front view of a cam shaft and a U-bend of FIG. 7.

### DETAILED DESCRIPTION OF THE PRESENT INVENTION

Embodiments of the present application are directed to a mounting mechanism. Those of ordinary skill in the art will realize that the following detailed description of the mounting mechanism is illustrative only and is not intended to be in any way limiting. Other embodiments of the mounting mechanism will readily suggest themselves to such skilled persons having the benefit of this disclosure.

Reference will now be made in detail to implementations of the mounting mechanism as illustrated in the accompanying drawings. The same reference indicators will be used throughout the drawings and the following detailed description to refer to the same or like parts. In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application and business related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Embodiments of the present application are directed to a mounting mechanism that includes new cam shaft design which isolates a rotational force from a translational force by the use of one or more sleeve bearings. Each sleeve bearing comes in contact with a U-bend in a metal sheet and is free to rotate or not rotate as the force is applied to the metal sheet from the rotating cam. The cam shaft is free to rotate independently within the sleeve bearing. This effectively reduces if not eliminates the kinetic friction against the U-bend of the metal sheet. The kinetic function is minimized within the sleeve bearing. In some embodiments, the sleeve bearing is a metal sleeve such as a bronze sleeve. A lubricating material can be added between the sleeve bearing and the cam surface. In other embodiments, the sleeve bearing is an impregnated metal sleeve, such as a steel sleeve impregnated with a low-friction material, such as Teflon, on its inner surface. In still other embodiments, the sleeve bearing has ball bearings or needle bearings. In general, the sleeve bearing can be any material made with low friction surface or surfaces.

By isolating the cam shaft from the metal sheet through the use of the sleeve bearing, one is free to choose the most appropriate cam shaft or sheet metal material without having to consider how the two materials wear. For example, without using a sleeve bearing, an aluminum cam shaft in direct contact with galvanized steel has a very high coefficient of friction and galling can occur, depending on the coating quality. With sleeve bearings, these materials are compatible and can operate with a torque of less than 50 inch-lbs, for example. A minimum amount of torque still needs to be applied to overcome the resistance of the metal sheet to bending.

The mounting mechanism described herein can be applied to any electronics sub-system including, but not limited to, a blade server and a rack server, herein referred to collectively as an electronics server. A server rack is configured to house multiple electronics servers, each electronics server mounted within a docking bay of the server rack. Each electronics server includes one or more heat generating devices as is well known in the art.

The mounting mechanism is positioned within the server rack. Each docking bay within the server rack is configured with one or more heat exchangers, such as cold plates, coupled to the metal sheet of the mounting mechanism. In some embodiments, the heat exchangers are fluid-based heat exchangers which have fluid passageways through which fluid flows. The heat exchangers are actuated via the mounting mechanism into thermal contact with the electronics server mounted in the docking bay. In some embodiments, the heat exchangers are thermally coupled to a housing of the electronics server. In other embodiments, the electronics server can be configured such that one side of the housing is open to expose one or more heat generating devices within the electronics server, and the heat exchangers are thermally coupled to the heat generating devices. When thermally coupled to the electronics server, heat is transferred from the electronics server to the fluid flowing through the heat exchangers. Fluid is delivered to the one or more heat exchangers in each docking bay using any conventional fluid distribution system. In some embodiments, the fluid is delivered using the cooling system described in the co-owned and co-pending U.S. patent application Ser. No. (Attorney Docket Number COOL-07001), filed on _______, and titled “Improved Flow Balancing Scheme for Two-phase Refrigerant Cooled Rack”, which is hereby incorporated in its entirety by reference.

Fundamental to cooling the electronics servers is the thermal interface formed between the electronics server and the one or more heat exchangers positioned at each docking bay of the server rack. The mounting mechanism provides means for bringing the one or more heat exchangers into thermal contact with the electronics server. The heat exchangers can take a variety of shapes, including planar, cylindrical, curvilinear, or other non-planar configurations. A heat exchanger can be a single solid piece or can be made up of an array of smaller heat exchangers to allow flexibility when mating non-planar surfaces. In some embodiments, each heat exchanger is itself flexible, allowing the heat exchanger to be bent into thermal contact with a portion of the electronics server.

The mounting mechanism used to engage and disengage the heat exchangers is configured to transfer a rotational force applied to the cam shaft to a translational force that moves the heat exchangers toward or away from the electronics server.

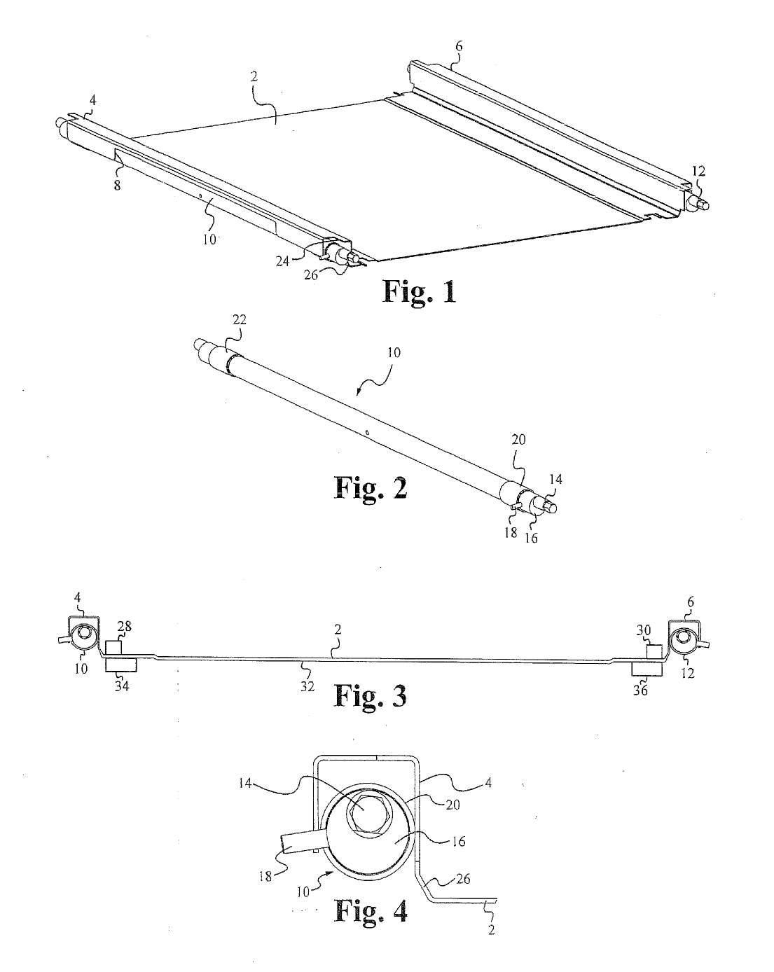

FIG. 1 illustrates an isometric view of a mounting mechanism according to an embodiment. The mounting mechanism includes a cam shaft 10, a cam shaft 12, and a metal sheet 2. Opposing ends of the metal sheet are formed into a U-bend 4 and a U-bend 6. The U-bend 4 and the U-bend 6 are integral to the metal sheet 2. The cam shaft 10 and the cam shaft 12 are supported in a frame structure (not shown), such as a server rack. FIG. 2 illustrates the cam shaft 10 of FIG. 1. The cam shaft 10 is also illustrative of the cam shaft 12. The cam shaft 10 includes a cam rod 14 positioned within a cam journal 16. In some embodiments, the cam shaft 10 is a single piece having the cam rod 14 and the cam journal 16 integrally formed therein. In other embodiments, the cam rod 14 and the cam journal 16 are separate pieces coupled together to form the cam shaft 10. The cam rod 14 is offset relative to a center axis of the cam journal 16. The cam rod 14 is secured at each end to the frame structure. The cam shaft 10 rotates about a center axis of the cam rod 14. A pin stop 18 extends from the cam journal 16. The cam shaft 10 includes one or more sleeve bearings. In the exemplary configuration of FIG. 2, the cam shaft 10 includes two sleeve bearings 20 and 22.

FIG. 3 illustrates a front view of the mounting mechanism of FIG. 1. FIG. 4 illustrates a larger view of the front view of the cam shaft 10 and the U-bend 4 of FIG. 3. Each sleeve bearing fits around a circumference of the cam journal 16, such as the sleeve bearing 20 shown in FIG. 4. One or more heat exchangers 32 are coupled to a bottom surface of the metal sheet 2. In some embodiments, the heat exchangers are fluid-based heat exchangers, such as cold plates. In some embodiments, each fluid-based heat exchanger is coupled to one or more fluid headers for inputting and outputting fluid to and from the heat exchangers. The one or more fluid headers are coupled to fluid lines for coupling the heat exchanger to a cooling loop. In some embodiments, each heat exchanger is a flexible cold plate. In an exemplary application, one or more flexible cold plates are coupled to the metal sheet and are flexed into thermal contact with an electronics server mounted in a docking bay of a server rack. An example of a flexible cold plate is described in U.S. Pat. No. 8,000,103, which is hereby incorporated in its entirety by reference. It is understood that alternative heat exchangers can be used. The heat exchangers can be coupled to the metal sheet using any conventional means, including, but not limited to, an adhesive.

The mounting mechanism is coupled to the frame structure so that the cam shafts 10 and 12 can be rotated between at least three different positions. The cam shafts 10 and 12 are each secured to the frame structure at the cam rod 14. Additionally, supports 28, 30, 34, and 36 are secured to the frame structure. In some embodiments, the heat exchangers 32 extends between the metal sheet 2 and the supports 34 and 36 to further secure the heat exchangers in place. The supports 34 and 36 also provide additional support for maintaining the mounting mechanism in a proper position relative to the frame structure. In some embodiments, the support 28 and the support 30 are each a single element extending along an entire length of the U-bend. In other embodiments, the support 28 and the support 30 are each representative of a support pin positioned at one end of the length of the U-bend, another support pin is positioned at the opposite end of the U-bend. The positions of the supports 28, 30, 34, and 36 are fixed.

Rotation of the cam shafts is accomplished by means of an actuation mechanism coupled to the end of the cam rod 14 shown in FIG. 4. In some embodiments, the end of the cam rod 14 is has a bolt shape with multiple flat surfaces, and the actuation mechanism is a wrench configured to mate with the bolt end of the cam rod. The cam rod can be rotated by rotating the wrench. It is understood that alternative actuation mechanisms, both manual and automated, can be used for rotating the cam shafts.

Rotation of the cam shafts 10 and 12 applies an actuation force to the portion of the metal sheet 2 between the U-bends 4 and 6. The actuation force functions to bend the metal sheet upward or downward depending on the rotational positions of the cam shafts. As stated above, the cam shafts rotate between at least three positions. In a first position, the actuation force is substantially zero and results in the metal sheet being substantially flat, as in FIG. 3. In a second position, the actuation force results in the metal sheet bending upward, as in FIG. 5. In a third position, the actuation force results in the metal sheet bending downward, as in FIG. 7.

FIG. 3 illustrates the cam shaft 10 and the cam shaft 12 in the first position, which results in the metal sheet being substantially flat. FIG. 4 illustrates a larger view of the cam shaft 10 and the U-bend 4 in FIG. 3. In the first position, the cam rod 14 is substantially centered between the two sides of the U-bend 4 with the offset portion of the cam journal 16 facing downward. In this first position, the cam journal 16 exerts a substantially zero amount of actuation force, also referred to as normal force, to the two sides of the U-bend 4. Also in the first position, there is a gap between the top surface of the U-bend 4 and the cam shaft 10. Discussion related to the cam shaft 10 can be similarly applied to the cam shaft 12.

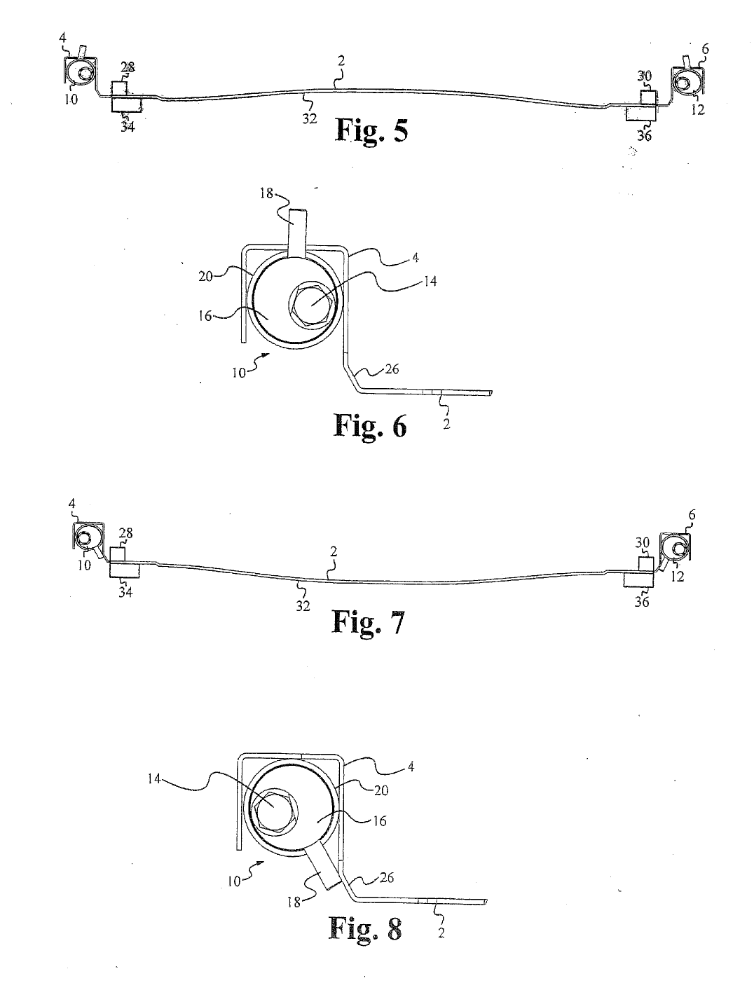

FIG. 5 illustrates a front view of the mounting mechanism with the cam shafts in the second position. FIG. 6 illustrates a larger view of the front view of the cam shaft 10 and the U-bend 4 of FIG. 5. FIGS. 5 and 6 show the cam shaft 10 in the second position, which results in the metal sheet 2 bending upward. Discussion related to operation of the cam shaft 10 can be similarly applied to the cam shaft 12, where the cam shaft 12 rotates in the opposite directions as the cam shaft 10 to achieve the same effects. In the second position, the cam shaft 10 is rotated substantially 90 degrees clockwise relative to the first position of FIGS. 3 and 4. The offset portion of the cam journal faces toward the outer side of the U-bend in the second position. As shown in FIG. 6, the offset portion of the cam journal 16 is positioned to the left of the cam rod 14 and faces the outer side of the U-bend 4. In this second position, the cam journal 16 exerts a normal force against the outer side of the U-bend. As the cam shaft 10 rotates from the first position to the second position, the offset cam journal 16 is forced against the outer side of the U-bend 4, resulting in both a normal force and a tangential force applied to the side of the U-bend. The tangential force is a force tangent to the sleeve bearing at the point of contact with the side of the U-bend. Without the sleeve bearings 20 and 22, as the cam shaft 10 rotates from the first position to the second position, the tangential force results in friction as the outer surface of the cam shaft rubs against the side of the U-bend 4. The friction requires a greater applied actuation force to rotate the cam shaft. The friction also results in degradation of the cam shaft surface and the U-bend surface. Inclusion of the sleeve bearings reduces if not eliminates the friction generated while rotating the cam shaft. With the sleeve bearings, as the cam shaft 10 rotates from the first position to the second position, the resulting tangential force is applied to the sleeve bearings 20 and 22 causing the sleeve bearings to rotate independently of the cam journal 16 thereby reducing if not eliminating friction between the two.

Although the cam shafts 10 and 12 are shown as each having two sleeve bearings, it is contemplated that one or more sleeve bearings can be used. In general, a sleeve bearing is positioned at each point along the cam shaft where there is normal force applied between the cam shaft and the U-bend during rotation of the cam shaft. It may appear as if there is contact between the cam shaft and the U-bend along the entire length of the cam shaft, but in practice the cam shaft may bend as the rotational actuation force is applied, resulting in only select areas along the cam shaft actually contacting the U-bend during rotation. In the exemplary configuration of FIG. 1, the cam shafts 10 and 12 bend outward when rotated, resulting in two contact areas between each cam shaft and the U-bend, the two contact areas are where the normal force and tangential force are applied. These two contact areas correspond to the positions of the sleeve bearings 20 and 22. Each of the U-bends can be further modified to include an opening, such as opening 8 in U-bend 4 (FIG. 1), so that the outward bending of the cam shaft does not contact the outer side of the U-bend. Alternatively, the U-bend does not include such an opening, and the cam shaft can be configured to include one or more additional sleeve bearings at the outward bending portion of the cam shaft. In yet another alternative embodiment, a single sleeve bearing can be used, where the single sleeve bearing extends the entire length of the cam journal 16. It is understood that the aforementioned embodiments are for illustrative purposes only and that alternative configurations are also contemplated.

Referring again to FIGS. 5 and 6, the cam shaft 10 rotates clockwise until the pin stop 18 reaches the stop 24 (FIG. 1) on the U-bend 4, this corresponds to the second position. The support pins 28 function as a pivot point and the support pins 30 function as another pivot point. The normal force supplied by the rotated cam shaft 10 applies the normal force to the outer side of the U-bend 4 and the normal force supplied by the rotated cam shaft 12 applies the normal force to the outer side of the U-bend 6. The normal force applied to the outer side of the U-bend forces the U-bend to move slightly outward and downward relative to its position in the first position. As applied to FIG. 5, the U-bend 4 is moved to the left (negative x-direction) and down (negative y-direction) relative to its position in the first position shown in FIG. 3. The cam rod 14 of camshaft 10 is fixed in place and therefore its position remains unchanged in the second position relative to the first position. Similarly, the U-bend 6 is moved to the right (positive x-direction) and down (negative y-direction) relative to its position in the first position shown in FIG. 3. The cam rod 14 of cam shaft 12 is fixed in place and therefore its position remains unchanged in the second position relative to the first position. The movement of the U-bends results in a rotational torque that is translated to the metal sheet between the two U-bends through the pivot points at the support pins 28 and 30, thereby bending the metal sheet upward, as shown in FIG. 5.

FIG. 7 illustrates a front view of the mounting mechanism with the cam shafts in the third position. FIG. 8 illustrates a larger view of the front view of the cam shaft 10 and the U-bend 4 of FIG. 7. FIGS. 7 and 8 show the cam shaft 10 in the third position, which results in the metal sheet 2 bending downward. Discussion related to operation of the cam shaft 10 can be similarly applied to the cam shaft 12, where the cam shaft 12 rotates in the opposite directions as the cam shaft 10 to achieve the same effects. In the third position, the cam shaft 10 is rotated substantially 90 degrees counter-clockwise relative to the first position of FIGS. 3 and 4. The offset portion of the cam journal faces toward the inner side of the U-bend in the third position. As shown in FIG. 8, the offset portion of the cam journal 16 is positioned to the right of the cam rod 14 and faces the inner side of the U-bend 4. In this third position, the cam journal 16 exerts a normal force against the inner side of the U-bend. As the cam shaft 10 rotates from the first position to the third position, the offset cam journal 16 is forced against the inner side of the U-bend 4, resulting in both a normal force and a tangential force applied to the side of the U-bend. As the cam shaft 10 rotates from the first position to the third position, the resulting tangential force is applied to the sleeve bearings 20 and 22 causing the sleeve bearings to rotate independently of the cam journal 16.

The cam shaft rotates clockwise until the pin stop 18 reaches the stop 26 (FIG. 1) on the U-bend 4, this corresponds to the third position. The normal force supplied by the rotated cam shaft 10 applies the normal force to the inner side of the U-bend 4 and the normal force supplied by the rotated cam shaft 12 applies the normal force to the inner side of the U-bend 6. The normal force applied to the inner side of the U-bend forces the U-bend to move slightly inward and upward relative to its position in the first position. As applied to FIG. 7, the U-bend 4 is moved to the right (positive x-direction) and up (positive y-direction) relative to its position in the first position shown in FIG. 3. The cam rod 14 of camshaft 10 is fixed in place and therefore its position remains unchanged in the third position relative to the first position. Similarly, the U-bend 6 is moved to the left (negative x-direction) and up (positive y-direction) relative to its position in the first position shown in FIG. 3. The cam rod 14 of cam shaft 12 is fixed in place and therefore its position remains unchanged in the third position relative to the first position. The movement of the U-bends 4 and 6 results in a rotational torque that is translated to the metal sheet between the two U-bends through the pivot points at the support pins 28 and 30, thereby bending the metal sheet downward, as shown in FIG. 7.

In operation, a metal sheet is bent upward or downward by rotating cam shafts from a first position to either a second position or a third position. Bending a metal sheet upward or downward can be used in a variety of applications, including, but not limited to, thermally engaging and disengaging a heat exchanger coupled to the metal sheet with a heat generating device, such as an electronics server. Each cam shaft is fitted with one or more sleeve bearings. Rotating a cam shaft from the first position to either the second or the third position forces an offset portion of the cam shaft against a side of a U-bend in the metal sheet. The rotation of the cam shaft against the side of the U-bend generates a normal force against the U-bend that is translated to a bending of the metal sheet. However, the rotation of the cam shaft against the side of the U-bend also generates a tangential force, which without one or more sleeve bearings coupled to the cam shaft, is manifested as friction between the metal sides of the U-bend and the rotating cam shaft. The sleeve bearings minimize if not negate the friction by rotating in response to the generated tangential force. In this manner, less torque is needed to rotate the cam shaft between positions, and wear and tear on the cam shaft and the U-bend due to friction is minimized, if not eliminated.

The present application has been described in terms of specific embodiments incorporating details to facilitate the understanding of the principles of construction and operation of the mounting mechanism. Many of the components shown and described in the various figures can be interchanged to achieve the results necessary, and this description should be read to encompass such interchange as well. As such, references herein to specific embodiments and details thereof are not intended to limit the scope of the claims appended hereto. It will be apparent to those skilled in the art that modifications can be made to the embodiments chosen for illustration without departing from the spirit and scope of the application.

What is claimed is:

1. A cam shaft comprising:
a. a cam journal have a first diameter and a center axis;
b. a cam rod having a second diameter less than the first diameter, wherein the cam rod is positioned within the cam journal and a center axis of the cam rod is offset relative to the center axis of the cam journal, further wherein the center axis of the cam rod is a rotational axis of the cam shaft;
c. one or more sleeve bearings, each sleeve bearing is coupled around a circumference of the cam journal, wherein the one or more sleeve bearings rotate relative to the cam journal.

2. The cam shaft of claim 1 wherein the cam journal and the cam rod rotate about the center axis of the cam rod.

3. The cam shaft of claim 1 wherein a first end of the cam rod extends beyond a first end of the cam journal.

4. The cam shaft of claim 3 wherein the first end of the cam rod comprises a bolt shape to mate with an actuating wrench.

5. The cam shaft of claim 1 wherein each sleeve bearing comprises ball bearings.

6. The cam shaft of claim 1 wherein each sleeve bearing comprises needle bearings.

7. The cam shaft of claim 1 wherein each sleeve bearing comprises an inner surface impregnated with a friction reducing material.

8. A mounting mechanism comprising:
a. a metal sheet having a first side and a second side, wherein the first side is formed as a first U-bend and the second side is formed as a second U-bend;
b. a first cam shaft positioned within the first U-bend, wherein the first cam shaft comprises a first set of one or more sleeve bearings coupled around a circumference of the first cam shaft; and
c. a second cam shaft positioned within the second U-bend, wherein the second cam shaft comprises a second set of one or more sleeve bearings coupled around a circumference of the second cam shaft.

9. The mounting mechanism of claim 8 wherein each of the first cam shaft and the second cam shaft comprises a cam journal, wherein the one or more sleeve bearings rotate relative to the cam journal.

10. The mounting mechanism of claim 9 wherein the cam journal has a first diameter and a center axis, further wherein each of the first cam shaft and the second cam shaft further comprises a cam rod having a second diameter less than the first diameter, wherein the cam rod is positioned within the cam journal and a center axis of the cam rod is offset relative to the center axis of the cam journal, wherein the center axis of the cam rod is a rotational axis of the cam shaft.

11. The mounting mechanism of claim 10 wherein the cam journal and the cam rod rotate about the center axis of the cam rod.

12. The mounting mechanism of claim 8 wherein the first cam shaft is configured to rotate within the first U-bend and the second cam shaft is configured to rotate within the second U-bend, wherein rotation of the first cam shaft results in a first normal force and a first tangential force between the first cam shaft and the first U-bend, the first tangential force rotates the first set of one or more sleeve bearings, further wherein rotation of the second cam shaft results in a second normal force and a second tangential force between the second cam shaft and the second U-bend, the second tangential force rotates the second set of one or more sleeve bearings, wherein the first normal force and the second normal force bends a portion of the metal sheet between the first U-bend and the second U-bend.

13. The mounting mechanism of claim 12 wherein each of the first cam shaft and the second cam shaft are rotated between a first position, a second position, and a third position such that in the first position the portion of the metal sheet is substantially flat, in the second position the portion of the metal sheet bends upward, and in the third position the portion of the metal sheet bends downward.

14. The mounting mechanism of claim 13 wherein each of the first U-bend and the second U-bend comprise a first side and a second side, the first side positioned proximate to the bending portion of the metal sheet and the second side distal from the bending portion of the metal sheet, further wherein when the first cam shaft and the second cam shaft are each in the third position, the normal force is applied to the first side of each of the first cam shaft and the second cam shaft.

15. The mounting mechanism of claim 13 wherein when the first cam shaft and the second cam shaft are each in the second position, the normal force is applied to the second side of each of the first cam shaft and the second cam shaft.

16. The mounting mechanism of claim 8 wherein the mounting mechanism further comprises one or more heat exchangers coupled to a surface of the metal sheet.

17. The mounting mechanism of claim 8 wherein the cam rod of each of the first cam shaft and the second cam shaft comprises a first end that extends beyond a first end of the cam journal.

18. The mounting mechanism of claim 17 wherein the first end of each cam rod comprises a bolt shape to mate with an actuating wrench.

19. The mounting mechanism of claim 8 wherein each sleeve bearing comprises ball bearings.

20. The mounting mechanism of claim 8 wherein each sleeve bearing comprises needle bearings.

21. The mounting mechanism of claim 8 wherein each sleeve bearing comprises an inner surface impregnated with a friction reducing material.

22. A system for thermally coupling a heat exchanger to a heat generating electronic device, the system comprising:
a. a mounting mechanism comprising:
i. a metal sheet having a first side and a second side, wherein the first side is formed as a first U-bend and the second side is formed as a second U-bend;
ii. a first cam shaft positioned within the first U-bend, wherein the first cam shaft comprises a first set of one or more sleeve bearings coupled around a circumference of the first cam shaft; and
iii. a second cam shaft positioned within the second U-bend, wherein the second cam shaft comprises a second set of one or more sleeve bearings coupled around a circumference of the second cam shaft;
b. one or more heat exchangers coupled to a surface of the metal sheet; and
c. a heat generating electronics device positioned proximate to the metal sheet, wherein the first cam shaft is configured to rotate within the first U-bend and the second cam shaft is configured to rotate within the second U-bend, wherein rotation of the first cam shaft results in a first normal force and a first tangential force between the first cam shaft and the first U-bend, the first tangential force rotates the first set of one or more sleeve bearings, further wherein rotation of the second cam shaft results in a second normal force and a second tangential force between the second cam shaft and the second U-bend, the second tangential force rotates the second set of one or more sleeve bearings, wherein the first normal force and the second normal force bends a portion of the metal sheet between the first U-bend and the second U-bend such that the one or more heat exchangers are thermally coupled to the heat generating electronics device.

23. A method of thermally coupling a heat exchanger to a heat generating electronic device, the method comprising:
a. rotating a first cam shaft positioned within a first U-bend configured at a first side of a metal sheet and rotating a second cam shaft positioned within a second U-bend con1d at a second side of the metal sheet, wherein rotation of the first cam shaft results in a first normal force and a first tangential force between the first cam shaft and the first U-bend, further wherein rotation of the second cam shaft results in a second normal force and a second tangential force between the second cam shaft and the second U-bend;
b. applying the first tangential force to a first set of one more sleeve bearings coupled to an outer circumference of the first cam shaft, thereby rotating each of the first set of sleeve bearings relative to the first cam shaft;
c. applying the second tangential force to a second set of one or more sleeve bearings coupled to an outer circumference of the second cam shaft, thereby rotating each of the second set of sleeve bearings relative to the second cam shaft; and
d. applying the first normal force and the second normal force to bend a portion of the metal sheet between the first U-bend and the second U-bend such that one or more heat exchangers coupled to the portion of the metal sheet are thermally coupled to the heat generating electronics device.
